(19) United States
(12) Patent Application Publication
(10) Pub. No.: US 2009/0001838 A1
(43) Pub. Date: Jan. 1, 2009

(54) Rotating Electrical Machine

(76) Inventors: Masayuki Okubo, Gunma (JP); Toshihiro Takeara, Gunma (JP)

Correspondence Address: WENDEROTH, LIND & PONACK, L.L.P., 2033 K STREET N. W., SUITE 800, WASHINGTON, DC, 20006-1021, US

(21) Appl. No.: 12/087,369

(22) PCT Filed: Jan. 10, 2007
(86) PCT No.: PCT/JP2007/050159

§ 371 Date: Jul. 2, 2008

(30) Foreign Application Priority Data
Jan. 10, 2006 (JP) 2006-002845

(51) Int. Cl. H02K 21/16

(52) U.S. Cl. 310/156.16

(57) ABSTRACT

There is provided a rotating electrical machine capable of suppressing backlash of a magnet in the trust direction and suppressing an axial variation in the fitting position of the magnet. A magnet holder 19 used for a motor 1 has a holder base 31 fixed to a rotary shaft and a plurality of holder arms 32 projecting from the holder base 31 in the extending direction of the rotary shaft. The holder base 31 has sidewall portions 53 between adjacent holder arms 32. On each sidewall portion 53, there is formed an inner end surface 53a opposed to an axial end portion 17c of the magnet 17. Projections 55 are formed on the inner end surfaces 53a, and the projections 55 are pressed and crushed by being brought into contact with the axial end portion 17c of the magnet 17. The magnet 17 is fitted in the holder arms 32 while pressing and crushing the projections 55. When the projections 55 are pressed and crushed, accumulated dimensional tolerance of the magnet 17 and the like is absorbed, and as a result, backlash of the magnet 17 in the thrust direction is suppressed.

### TECHNICAL FIELD

The present invention relates to a rotating electrical machine such as a motor and generator and, more particularly to, a rotating electrical machine provided with a magnet holder having a comb-shaped arm.

### BACKGROUND ART

A permanent magnetic field has been used in many small-size motors and generators. At the time of use of the permanent magnetic field, a magnet is often fixed to a rotor or stator by using an adhesive. Further, as disclosed in Patent Documents 1 and 2, a method in which a magnet is provided on the outer periphery of a rotor core or rotary shaft and the magnet is mold-fixed by a non-magnetic member is known. Patent Document 1 discloses a method of filling the gaps between the magnets with nonmagnetic member through die cast molding, and Patent Document 2 discloses a method of integrally molding a magnet on the outer periphery of a rotor core using a synthetic resin. In these methods, the magnet can be fixed to the rotor core or the like without a use of an adhesive.

As the method not requiring an adhesive, there is often used a method using a magnet holder having a comb-shaped arm as disclosed in Patent Documents 3 and 4. FIG. 13 is a perspective view showing a magnet fixing structure in the case where the magnet holder is used. A magnet holder 101 of FIG. 13 is formed of a non-magnetic member (or a member covered by a non-magnetic material) and is fixed to a rotary shaft 107. The magnet holder 101 includes a holder base 102 to be fixed to the rotary shaft and a plurality of holder arms 103 extending in the axial direction from one end of the holder base 102. Holder fitting grooves 105 are formed, along the axial direction, on the outer periphery of the rotor core 104, and the holder arms 103 are fixedly fitted to the holder fitting grooves 105. A magnet 106 (106a, 106b) is inserted by a sort of press-fitting, in the axial direction, between the holder arms 103 fitted to the rotor core 104 and is fixed to the outer periphery of the rotor core 104.

### [Patent Document 1]

Jpn. Pat. Appln. Laid-Open Publication No. 05-153745

### [Patent Document 2]

Jpn. Pat. Appln. Laid-Open Publication No. 09-19091

### [Patent Document 3]

Jpn. Pat. Appln. Laid-Open Publication No. 2004-129369

### [Patent Document 4]

Jpn. Pat. Appln. Laid-Open Publication No. 2005-45978

### [Patent Document 5]

Jpn. Pat. Appln. No. 2004-210085

### DISCLOSURE OF THE INVENTION

### Problems to be Solved by the Invention

However, in the magnet fixing structure as shown in FIG. 13, the axial direction length of the rotor core 104 is set longer than that of the magnet 106 on size relations, so that when the magnet 106 is disposed on the rotor core 104, gaps G as shown in FIG. 14 may be created in the axial direction. That is, backlash corresponding to the tolerance is likely to occur in the axial direction of the magnet 106. When such backlash in the thrust direction exists, the magnet 106 may be damaged due to vibration at the time of use of a rotating electrical machine. In particular, in the case of a motor having a longer axial direction length, i.e., when a plurality of magnets are disposed in the axial direction, a dimensional tolerance is accumulated to easily cause large backlash.

An object of the present invention is to provide a rotating electrical machine capable of suppressing backlash of a magnet in the trust direction and suppressing an axial variation in the fitting position of the magnet.

### Means for Solving the Problems

According to the present invention, there is provided a rotating electrical machine having: a rotor core fixed to a rotary shaft; a plurality of magnets fitted to the rotor core on the outer periphery thereof along the circumferential direction; and a magnet holder including a base portion fixed to the rotary shaft and a plurality of arm members projecting from the base portion in the extending direction of the rotary shaft so as to be able to contain and hold the magnet between the adjacent arm members, characterized in that the base portion has a deformable portion which is deformed by being brought into contact with the axial direction end portion of the magnet.

In the present invention, a deformable portion which is pressed and crushed by being brought into contact with the axial direction end portion of the magnet is formed on the base portion, and the magnet is inserted between the arm members while the deformable portion is deformed. With this configuration, accumulated dimension tolerance of the magnet, rotor core, and the like is absorbed by the deformation of the deformable portion, thereby suppressing backlash of the magnet in the axial direction and suppressing an axial variation in the fitting position of the magnet.

In the rotating electrical machine, an opposite surface that is opposed to the axial direction end portion of the magnet may be formed between the adjacent arm members of the base portion. Further, the deformable portion may be formed on the opposite surface so as to be pressed and crushed by being brought into contact with the axial direction end portion of the magnet. That is, in the rotating electrical machine, the deformable portion, which is pressed and crushed by being brought into contact with the axial direction end portion of the magnet, is formed on the opposite surface that is formed between the adjacent arm members and is opposed to the axial direction end portion of the magnet, and the magnet is inserted between the arm members while the deformable portion is pressed and crushed. With this configuration, accumulated dimension tolerance of the magnet, rotor core, and the like is absorbed by the crushing amount of the deformable portion, thereby suppressing backlash of the magnet in the axial direction and suppressing an axial variation in the fitting position of the magnet.

In the rotating electrical machine, a projection may be formed as the deformable portion on the opposite surface so as to project from the opposite surface. In this case, a cavity may be formed inside the projection, or a cavity portion may be formed in the base portion at the back of the projection.

The deformable portion may be formed near the connection portion between the arm member and base portion so as to be pressed and crushed by being brought into contact with the axial direction end portion of the magnet. That is, in the rotating electrical machine, the deformable portion, which is pressed and crushed by being brought into contact with the axial direction end portion of the magnet, is formed on the base portion of the arm member, and the magnet is inserted between the arm members while the deformable portion is pressed and crushed. With this configuration, accumulated dimension tolerance of the magnet, rotor core, and the like is absorbed by the crushing amount of the deformable portion, thereby suppressing backlash of the magnet in the axial direction and suppressing an axial variation in the fitting position of the magnet.

In the rotating electrical machine, an expanded portion may be formed as the deformable portion on the base portion of the arm member so as to expand in the radial direction. In this case, a slit penetrating the expanded portion in the radial direction may be formed inside the expanded portion, or a cavity may be formed inside the expanded portion.

In the rotating electrical machine, an opposite surface that is opposed to the axial direction end portion of the magnet may be formed between the adjacent arm members of the base portion and, further, an elastic piece may be formed as the deformable portion on the opposite surface so as to be displaced in the axial direction by being brought into contact with the axial direction end portion of the magnet. That is, in the rotating electrical machine, the elastic piece, which is displaced in the axial direction by being brought into contact with the axial direction end portion of the magnet, is formed on the opposite surface that is formed between the arm members and opposed to the axial direction end portion of the magnet, and the magnet is inserted between the arm members while the elastic piece is deformed. With this configuration, accumulated dimension tolerance of the magnet, rotor core, and the like is absorbed by the crushing amount of the deformable portion, thereby suppressing backlash of the magnet in the axial direction and suppressing an axial variation in the fitting position of the magnet. In this case, an elastic piece housing hole into which the elastic piece can move may be formed at the portion on the base portion that faces the elastic piece.

### ADVANTAGES OF THE INVENTION

The rotating electrical machine according to the present invention has: a rotor core fixed to a rotary shaft; a plurality of magnets fitted to the rotor core on the outer periphery thereof along the circumferential direction; and a magnet holder including a base portion fixed to the rotary shaft and a plurality of arm members projecting from the base portion in the extending direction of the rotary shaft so as to contain and hold the magnet between the adjacent arm members, and since a deformable portion which is deformed by being brought into contact with the axial direction end portion of the magnet is formed on the base portion, the deformable portion is deformed when the magnet is fitted to the holder, so that accumulated dimensional tolerance of the magnet, rotor core, and the like can be absorbed by the deformation of the deformable portion. As a result, it is possible to suppress backlash of the magnet in the axial direction and prevent the magnet from being damaged due to vibration, thereby increasing the life and reliability of the rotating electrical machine. In particular, in the case of the machine having a longer axial direction length, i.e., when a plurality of magnets are disposed in the axial direction, backlash of the magnet in the axial direction can effectively be suppressed. Further, the fitting positions of the magnets can be aligned to each other, and displacement of the magnet in the axial direction can be prevented, whereby motor characteristics become stable. Furthermore, accumulated dimensional tolerance is absorbed by the deformable portion, so that the processing accuracy of the magnet and the like can be reduced and the manufacturing cost can be lowered.

Further, in the rotating electrical machine according to the present invention, since an opposite surface that is opposed to the axial direction end portion of the magnet is formed between the adjacent arm members of the base portion, and the deformable portion is formed on the opposite surface so as to be pressed and crushed by being brought into contact with the axial direction end portion of the magnet, the deformable portion is pressed and crushed when the magnet is fitted to the holder, so that accumulated dimensional tolerance of the magnet, rotor core, and the like can be absorbed by the crushing amount of the deformable portion. As a result, it is possible to suppress backlash of the magnet in the axial direction and prevent the magnet from being damaged due to vibration, thereby increasing the life and reliability of the rotating electrical machine.

Further, in the rotating electrical machine according to the present invention, since the deformable portion is formed near the connection portion between the arm member and base portion so as to be pressed and crushed by being brought into contact with the axial direction end portion of the magnet, the deformable portion is pressed and crushed when the magnet is fitted to the holder, so that accumulated dimensional tolerance of the magnet, rotor core, and the like can be absorbed by the crushing amount of the deformable portion. As a result, it is possible to suppress backlash of the magnet in the axial direction and prevent the magnet from being damaged due to vibration, thereby increasing the life and reliability of the rotating electrical machine.

Further, in the rotating electrical machine according to the present invention, since an opposite surface that is opposed to the axial direction end portion of the magnet may be formed between the adjacent arm members of the base portion and, further, an elastic piece is formed as the deformable portion on the opposite surface so as to be displaced in the axial direction by being brought into contact with the axial direction end portion of the magnet, the elastic piece is displaced when the magnet is fitted to the holder, so that accumulated dimensional tolerance of the magnet, rotor core, and the like can be absorbed by the displacement of the elastic piece. As a result, it is possible to suppress backlash of the magnet in the axial direction and prevent the magnet from being damaged due to vibration, thereby increasing the life and reliability of the rotating electrical machine.

### BRIEF DESCRIPTION OF THE DRAWINGS

FIG. 1 is a cross-sectional view showing a configuration of a brushless motor which is an embodiment of the present invention;

FIG. 2 is an exploded perspective view of the brushless motor of FIG. 1;

FIG. 3 is a perspective view of a magnet holder used in the brushless motor of FIG. 1;

FIG. 4 is a front view of the magnet holder of FIG. 3;

FIG. 5 is a cross-sectional view taken along B-B line of FIG. 4;

FIG. 6 is a rear view of the magnet holder of FIG. 3;

FIG. 7 is an explanatory view schematically showing a configuration of a holder arm;

FIG. 8 is an enlarged view of portion P in FIG. 6;

FIG. 9 (a) is a cross-sectional view taken along C-C line of FIG. 8, and FIG. 9 (b) is a cross-sectional view taken along D-D line of FIG. 8;

FIG. 10 is a cross-sectional view taken along A-A line of FIG. 1;

FIG. 11 is an enlarged view of portion Q in FIG. 10;

FIGS. 12 (a) to (e) are explanatory views showing modifications of the magnet holder;

FIG. 13 is a perspective view showing a magnet fixing structure in the case where a conventional magnet holder is used; and

FIG. 14 is an explanatory view showing a problem in the conventional magnet holder.

### EXPLANATION OF REFERENCE SYMBOLS

| | |
|---|---|
| 1: | Brushless motor (rotating electrical machine) |
| 2: | Rotor shaft (rotary shaft) |
| 3: | Joint |
| 4: | Motor section |
| 5: | Sensor section |
| 6: | Stator |
| 7: | Rotor |
| 8: | Hall element |
| 11: | Drive coil |
| 12: | Stator core |
| 13: | Yoke |
| 14: | Bracket |
| 15a, 15b: | Bearing |
| 16: | Rotor core |
| 16a: | Rotor core outer periphery |
| 17: | Rotor magnet |
| 17a, 17b: | Rotor magnet |
| 17c: | Axial direction end portion |
| 18: | Side plate |
| 19: | Magnet holder |
| 20: | Sensor magnet |
| 21: | magnet cover |
| 21a: | Small diameter portion |
| 21b: | Large diameter portion |
| 21c: | Tapered portion |
| 22: | Sensor holder |
| 23: | Screw |
| 24: | Printed board |
| 25: | End cap |
| 26: | Power supply cable |
| 27: | Rubber grommet |
| 31: | Holder base (base portion) |
| 32: | Holder arm (arm member) |
| 33: | Sensor magnet fitting portion |
| 41: | Arm main body |
| 41a: | End portion |
| 42: | Magnet holder piece |
| 43: | Magnet housing section |
| 44: | Engagement projection |
| 45: | Holder anchoring groove |
| 45a: | Opening portion |
| 45b: | Bottom portion |
| 46: | First contact portion |
| 47: | Second contact portion |
| 48: | Non-contact portion |
| 49: | Gap |
| 51: | Bridge portion |
| 52: | Cut portion |
| 53: | Side wall portion |
| 53a: | Inner end surface (opposite surface) |
| 54: | Void portion |
| 55: | Projection (deformable portion) |
| 56: | Concave portion |
| 57: | Expanded portion (deformable portion) |
| 58: | Slit |
| 59: | Slit |
| 61: | projection |
| 62: | Die cavity |
| 63: | projection |
| 64: | Cavity portion |
| 65: | Elastic piece (deformable portion) |
| 66: | Housing cavity |
| W₁: | Bridge portion width dimension |
| W₂: | Arm main body width dimension |
| W₃: | Projection peripheral direction width |
| W₄: | Projection radial direction width |
| 101: | Magnet holder |
| 102: | Holder base |
| 103: | Holder arm |
| 104: | rotor core |
| 105: | Holder fitting groove |
| 106: | Magnet |
| 106a, 106b: | Magnet |
| 107: | Rotary shaft |

### BEST MODE FOR CARRYING OUT THE INVENTION

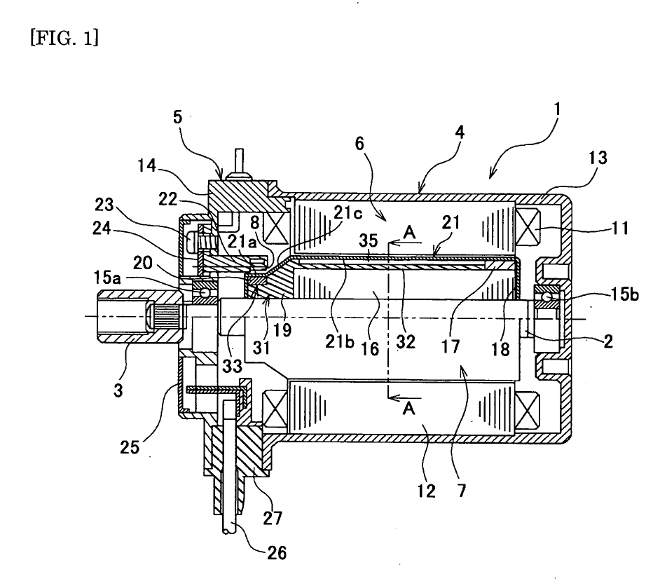

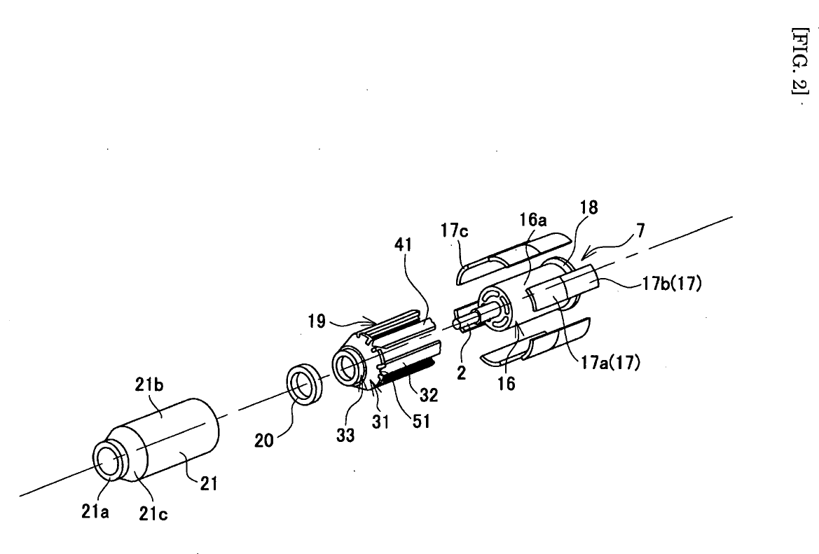

An embodiment of the present invention will be described below with reference to the accompanying drawings. FIG. 1 is a cross-sectional view showing a configuration of a brushless motor (rotating electrical machine) which is an embodiment of the present invention, and FIG. 2 is an exploded perspective view of the brushless motor of FIG. 1. A brushless motor 1 (hereinafter abbreviated as “motor 1”) shown in FIGS. 1 and 2 is used as a drive source of an electric power steering apparatus and, when a driver operates a steering wheel, supplies an auxiliary steering force according to the steering angle of the steering wheel or vehicle running speed. A rotor shaft (rotary shaft) 2 of the motor 1 is connected to an input shaft of a gearbox (not shown) via a joint 3. A rotation of the motor 1 is appropriately decelerated in the gearbox and then transmitted to a steering column, whereby the steering force is assisted by the torque of the motor 1.

The motor 1 is roughly constituted by a motor section 4 and a sensor section 5. The motor section 4 includes a stator 6 and a rotor 7. Hall elements (magnetic detection elements) 8 are disposed in the sensor section 5. The rotor 7 is rotatably disposed inside the stator 6, that is, the motor 1 is configured to be a brushless motor of an inner rotor type.

The stator 6 includes a stator core 12 around which a drive coil 11 is wound and a metal-made yoke 13 for containing the stator core 12. The stator core 12 is formed by laminating metal plates made of a magnetic material. A salient pole projects at the inner peripheral side of the stator core 12 and a drive coil 11 is wound around the salient pole to form a winding. The yoke 13 has a bottomed cylindrical shape and is made of a magnetic material. A bracket 14 formed by aluminum die casting (or synthetic resin) is fitted to the open end side of the yoke 13.

A rotor shaft 2 is arranged in the rotor 7. The rotor shaft 2 is supported by bearings 15a, 15b fitted respectively to the yoke 13 and bracket 14 so as to be freely rotated. A rotor core 16 is fixed to the rotor shaft 2. The rotor core 16 is formed by laminating metal plates made of a magnetic material. Segment-shaped rotor magnets 17 are fitted to the outer periphery of the rotor core 16. A set of two rotor magnets 17 (17a, 17b) (hereinafter, abbreviated as “magnet 17”) is fitted in the axial direction, and a total of six sets of two magnets 17 are fitted in the circumferential direction. A side plate 18 is fitted to the axial direction end of the rotor core 16.

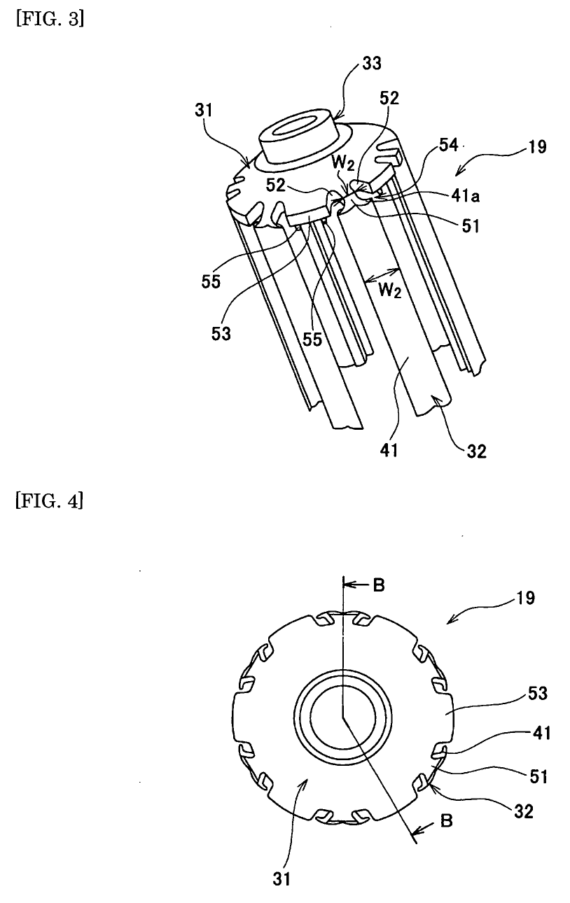

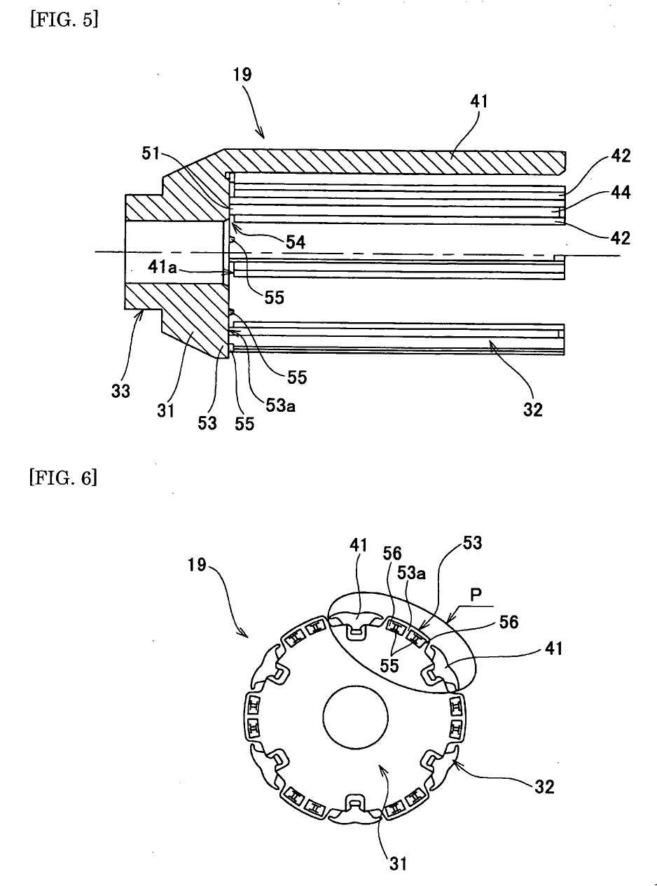

Additionally, a magnet holder 19 made of a synthetic resin is fixed to the rotor shaft 2. FIG. 3 is a perspective view of the magnet holder 19, FIG. 4 is a front view thereof, FIG. 5 is a cross-sectional view taken along B-B line of FIG. 4, and FIG. 6 is a rear view of the magnet holder 19. As shown in FIGS. 3 and 5, the magnet holder 19 includes a holder base (base portion) 31 fixed to the rotor shaft 2 and holder arms (arm members) 32 axially projecting from the holder base 31. A sensor magnet fitting portion 33 is formed, in a cut manner, at the end of the holder base 31. A sensor magnet 20 is to be fitted to the sensor magnet fitting section 33.

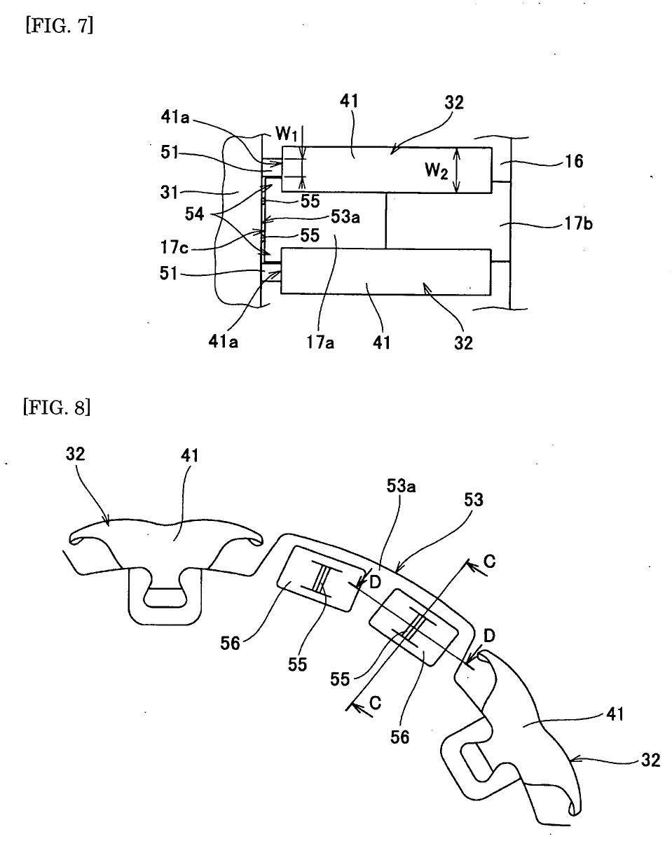

Each of the holder arms 32 is a cantilever structure extending in the axial direction from the holder base 31. Each of the holder arms 32 has an arm main body 41 extending in the axial direction and a bridge portion 51 connecting the arm main body 41 and holder base 31. FIG. 7 is an explanatory view schematically showing a configuration of the holder arms 32. As shown in FIG. 7, a width dimension W₁ of the bridge portion 51 in the circumferential direction is set smaller than a width dimension W₂ of the arm main body 41 (W₁<W₂). Cut portions 52 are formed on both sides of the bridge portion 51 in the circumferential direction. A side wall portion 53 is formed between the adjacent bridge portions 51 such that the cut portions 52 is interposed between the adjacent side wall portions 53.

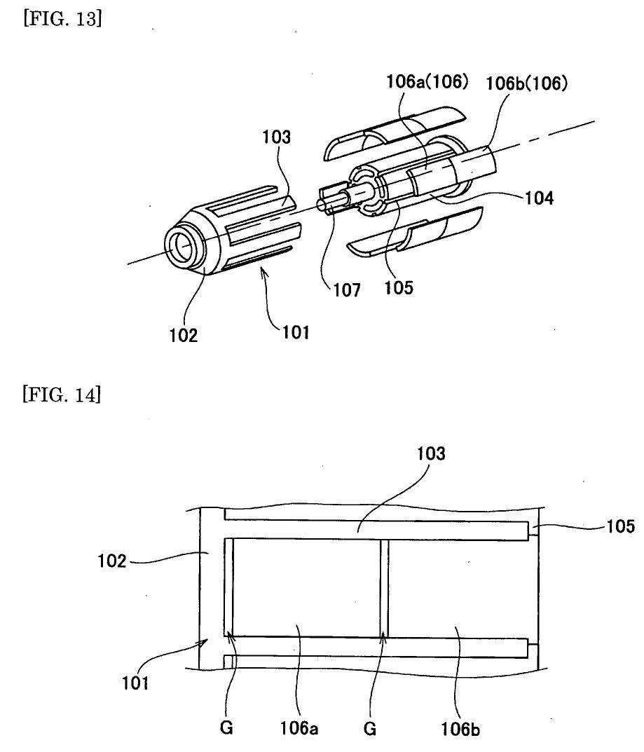

As shown in FIGS. 3 and 7, the holder arms 32 are supported by the holder base 31 at the respective narrow bridge portions 51. Therefore, the bridge portions 51 are configured to be elastically flexible in the circumferential direction, so that the rigidity in the arm base portion is reduced as compared to the magnet holder 101 shown in FIG. 13. An end portion 41a of the arm main body 41 on the bridge portion 51 side (left end portion in FIG. 5) is positioned away from the inner end surface (opposite surface) 53a in the axial direction. As a result, a void portion 54 is formed between the end portion 41a and inner end surface 53a based on the difference between W₁ and W₂.

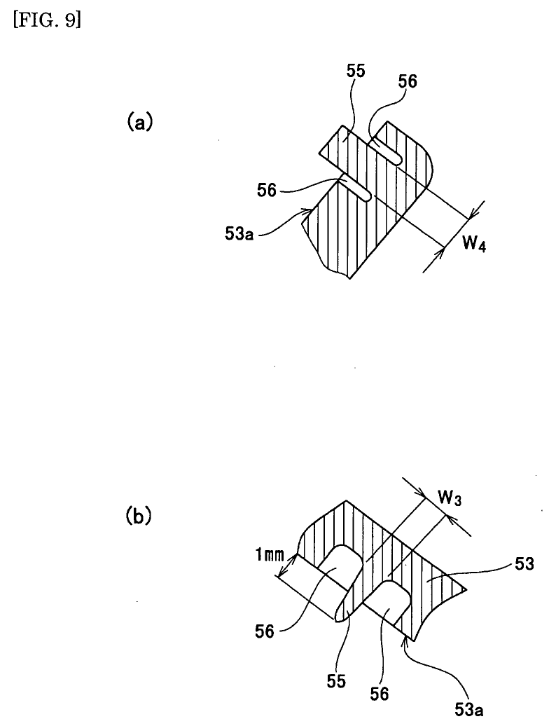

As shown in FIGS. 3, 5, and 6, in the motor 1 according to the present invention, projections (deformable portions) 55 project in the axial direction from the inner end surface 53a of the side wall portion 53 of the magnet holder 19. FIG. 8 is an enlarged view of portion P in FIG. 6, FIG. 9 (a) is a cross-sectional view taken along C-C line of FIG. 8, and FIG. 9 (b) is a cross-sectional view taken along D-D line of FIG. 8. As shown in FIG. 8, two projections 55 are arranged in the circumferential direction on the side wall portion 53. As shown in FIG. 9, each projection 55 projects from the bottom portion of a concave portion 56 with a depth of about 1.5 mm, which is formed in the side wall portion 53, and, as shown in FIG. 9 (b), the leading end portion of the projection 55 is tapered. The circumferential direction width W₃ of the base portion of the projection 55 is about 1 mm, and radial direction width W₄ thereof is about 1.5 mm. The leading end of the projection 55 projects by about 1 mm from the inner end surface 53a of the side wall portion 53.

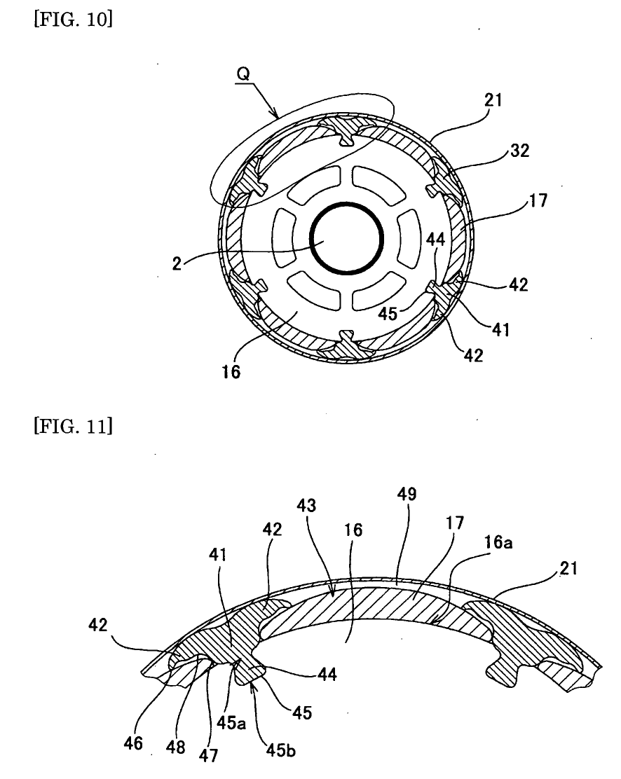

FIG. 10 is a cross-sectional view taken along A-A line of FIG. 1, and FIG. 11 is an enlarged view of portion Q in FIG. 10. As shown in FIG. 11, each of the holder arms 32 has substantially a T-shaped cross section, and a pair of magnet holder pieces 42 is formed on the outer peripheral side of the arm main body 41 that extends in the axial direction. A magnet housing section 43 is defined by the magnet holder pieces 42 and an outer peripheral surface 16a of the rotor core 16 between the magnet holder pieces 42 that are located vis-à-vis relative to each other of the adjacently located holder arms 32. A segment-shaped rotor magnet 17 is axially put into the magnet housing section 43 by press-fitting and held in the magnet housing section 43.

An engagement projection 44 is formed on the inner peripheral side of the arm main body 41. The engagement projection 44 is to be engaged with a holder anchoring groove 45 formed on the outer peripheral part of the rotor core 16. The holder anchoring groove 45 extends along the axial direction of the rotary shaft. A total of six holder anchoring grooves 45 are provided in the circumferential direction of the rotor core 16. The opening part 45a of each of the holder anchoring grooves 45 is made narrower than the bottom part 45b thereof. The engagement projection 44 is made to show a matching profile and hence has a substantially trapezoidal cross section. When the engagement projection 44 is put into the holder anchoring groove 45 in the axial direction, the engagement projection 44 having substantially a trapezoidal cross section becomes tightly engaged with the holder anchoring groove 45 and holder arm 32 is fixed to the outer peripheral surface 16a of the rotor core 16 and prevented from being released in the radial direction.

As shown in FIG. 11, the magnet holder pieces 42 extend in the circumferential direction from the arm main body 41 so as to face the outer peripheral surface 16a of the rotor core 16 with a gap interposed therebetween. A first contact section 46 is arranged at the front end of each of the magnet holder pieces 42. When the magnet 17 is put into the corresponding magnet housing section 43, a first contact section 46, which is located at the leading end of the magnet holder piece 42, contacts the outer peripheral surface of the magnet 17. A second contact section 47 is arranged on the arm main body 41 and it projects in the peripheral direction. When the magnet 17 is put into the magnet housing section 43, the second contact section 47 also contacts the outer peripheral surface of the magnet 17. A non-contact portion 48 that does not contact the magnet 17 is arranged between the first contact section 46 and the second contact section 47 to create a gap between itself and the magnet 17.

The magnets 17 are fitted to the rotor core 16 fixed to the rotor shaft 2 and the magnet holder 19 from the free end side (the right end side in FIG. 5) of the holder arms 32, one by one, in the order of magnet 17a and magnet 17b. The gap between each of the first contact sections 46 and the outer peripheral surface 16a of the rotor core is made to be slightly smaller than the thickness of the corresponding part of the corresponding magnet 17 to be fitted thereto when the related magnet holder pieces 42 are free. The distance between the two second contact sections 47 that are arranged vis-à-vis in the magnet housing section 43 is made to be slightly smaller than the width of the magnet 17 in the circumferential direction. Thus, the magnet 17 is press-fitted into the magnet housing section 43 in the axial direction as it pushes to open the corresponding magnet holder pieces 42 outwardly and pushes the corresponding arm main body 41 in the circumferential direction.

When the magnet 17a is press-inserted between the holder arms 32, an axial direction end portion 17c of the magnet 17 faces the inner end surface 53a of the side wall portion 53. When the press insertion of the magnet 17 is continued, the axial direction end portion 17c abuts the projections 55 formed in the inner end surface 53a. In the motor 1, the insertion of the magnets 17a and 17b is continued after the magnet 17a has been brought into contact with the projections 55 while crushing the projections 55 by the axial direction end portion 17c of the magnet 17a until the rear end surfaces (right end surface in FIG. 1) of the magnet 17b and rotor core 16 correspond to each other. After the fitting of the magnet 17, the magnet holder 19 is covered by a magnet cover 21 from the outside, so that the magnet 17 is held in the radial direction and thereby the movement of the magnet 17 in the axial direction is restricted (magnet 17 is prevented from being released in the axial direction).

Meanwhile, the magnet 17 and rotor core 16 have dimensional tolerance, respectively. In particular, in the case where a plurality of magnets are disposed in the axial direction, the dimensional tolerance is accumulated to easily cause backlash in the axial direction. In the case of the motor 1 in which the magnet 17 is fitted while the projection 55 are pressed and crushed, the dimensional tolerance is absorbed by the crushing amount of the projection 55. Therefore, even in the case of a motor having a longer axial direction length, i.e., even when a plurality of magnets 17 are disposed in the axial direction, the axial direction backlash does not occur in the magnet 17, preventing the magnet 17 from being damaged due to vibration. Further, the fitting positions of the magnets 17 in the circumferential direction can be aligned to each other, and displacement of the magnet 17 in the axial direction can be prevented, whereby motor characteristics become stable. Furthermore, the accumulated tolerance is absorbed by the projection 55, so that the processing accuracy of the magnet 17 and rotor core 16 can be reduced and the manufacturing cost can be lowered.

In the case of the conventional magnet holder 101 as shown in FIG. 13 in which the rigidity of the base portion 103a of the holder arm 103 is high, when the magnet 17a is pressed to the side wall portion inner end surface 53a to the fullest, there have arisen problems that the arm end portions 103b spread in the circumferential direction, or the magnet 106 cannot be inserted all the way to the back. On the other hand, in the motor 1, the rigidity of the base portion of the holder arm 32 in the magnet holder 19 is reduced to a lower level, so that when the magnet 17a is inserted all the way to the back, bending of the bridge portion 51 allows the magnet 17 to be elastically held by the holder arms 32. Thus, it is possible to prevent the end portions of the holder arms 32 from spreading in the circumferential direction as well as to prevent the backlash from occurring in the magnet 17, whereby motor performance and reliability of motor operation can be enhanced.

Further, as shown in FIG. 7, when the magnet 17a is inserted all the way, the end portion of the magnet 17a is housed in the void section 54. In the void portion 54, the distance between the bridge portions 51 adjacently disposed in the circumferential direction is set slightly larger than the circumferential direction dimension of the magnet 17a. Therefore, the end portion of the magnet 17a is housed in the void portion 54 without being restricted by the holder arm 32. That is, in the motor 1, the magnet 17a is not closely held up to the root of the holder arms 32 of the magnet holder 19, so that a stress produced in the holder arms 32 at the magnet insertion time is alleviated. This makes it easy to insert the magnet 17a between the holder arms 32, allowing the magnet 17a to reliably be inserted up to the base portion of the holder arms 32.

The magnet 17 press-fitted into the corresponding magnet housing section 43 is held in it by the elastic resilience of the magnet holder pieces 42 and the arm main body 41. In this condition, the radial movement of the magnet 17 is limited by the corresponding first contact sections 46 whereas the circumferential movement of the magnet 17 is limited by the corresponding second contact sections 47. In other words, the magnet 17 is rigidly held to the outer peripheral surface 16a of the rotor core 16 by the elastic resilience of the magnet holder 19 without any adhesive. Thus, the magnet is free from the tensile force that is produced due to the difference in the thermal deformation rate of the components operating on the magnet 17 when adhesive is used and hence from the risk of being broken due to the difference in the coefficient of linear expansion.

Additionally, the magnet 17 is supported by the first and second contact sections 46, 47 and a non-contact area 48 is arranged between them, so that if the ambient temperature rises when the motor is in operation and the magnet 17 thermally expands, the magnet 17 is not constrained firmly by the holder arms 32. Therefore, the stress that is produced in the magnet 17 due to deformation and constraint can be alleviated to prevent the magnet from being broken.

Furthermore, since no adhesive is used, there arises no problem due to the dispersion of bonding strength according to the bonding conditions and the quantity of the applied adhesive and the degradation of the adhesive agent in a hot environment so that the product quality will be improved. Since the holder arms 32 are aligned by the holder anchoring grooves 45, it is possible to accurately align and anchor the magnets and stabilize the product characteristics. No anti-rotation mechanism is required when aligning the magnets, so that the apparatus structure can be simplified and the assembling man-hours can be reduced. Additionally, since the motor is assembled only by means of an assembling operation of press-fitting the magnets 17, neither the adhesive applying operation nor the time for hardening the adhesive in the assembling process is required to reduce the number of manufacturing facilities, the man-hours and hence the manufacturing cost including the cost of the adhesive can be reduced.

Meanwhile, the magnet 17 generally requires a large dimensional tolerance and, when rare earth magnets are used for the magnet 17, the magnet can rust when the surfaces of the magnets are scarred. Thus, it is necessary to avoid excessive press-fitting force while a sufficient level of pressure is secured to hold the magnet 17 there. In view of these circumstances, in a magnet fixing structure according to the present invention, since the cross sectional shape of the magnet housing section 43 is differentiated from that of the magnet 17 and the first and second contact sections 46, 47 support the magnet 17 at the two points and the non-contact area 48 is arranged between them, the change in the press-fitting force due to the dimensional tolerance is alleviated. Accordingly, even if the magnet 17 shows a dimensional variation, it is possible to press-fit the magnet 17 into the magnet housing section 43 flexibly with a constant pushing force, so that the magnets are prevented from being broken in the assembling process.

A ring-shaped sensor magnet 20 is fitted to the sensor magnet fitting portion 33. The sensor magnet fitting portion 33 is formed at the leading end of the holder base 31 (left end in FIG. 4) by cutting the latter to form a step. The sensor magnet 20 is to be fitted to the sensor magnet fitting section 33 from the outside. The magnetic polarities of the sensor magnet 20 correspond to those of the magnets 17, the number of poles of the sensor magnet 20 being same as those of the rotor magnets 17, and are arranged at positions same as those of the magnets 17 as viewed in the peripheral direction. In the case of the above-described motor 1, six rotor magnets 17 are provided and hence the sensor magnet 20 is made to have six magnetic poles in the peripheral direction.

The magnet holder 19 is covered by a magnet cover 21 from the outside. The magnet cover 21 is made of a non-magnetic material such as stainless steel or aluminum and formed by deep drawing. The magnet cover 21 is provided with a small diameter portion 21a for covering the sensor magnet 20 and a large diameter portion 21b for covering the magnets 17. A tapered section 21c is arranged between the small diameter section 21a and the large diameter section 21b.

The magnet cover 21 is fitted to the magnet holder 19 carrying the magnets 17 and the sensor magnet 20 from the side of the holder base 31. The opening end portion (right end side in FIGS. 1 and 2) of the magnet cover 21 is caulking-fixed in such a manner as to hold the rear end surfaces of the magnet 17b and rotor core 16. This prevents the magnets 17 from being released in the axial direction. The inner diameter of the magnet cover 21 is made slightly smaller than the outer diameter of the holder arms 32, the magnet cover 21 is fitted to the outside of magnet holder 19 by a sort of press-fitting. Note, however, that the outer diameter of the magnet 17 is smaller than the inner diameter of the magnet cover 21 when they are fitted to the outer peripheral surface 16a of the rotor core 16.

In other words, when the magnets 17 are fitted to the respective magnet housing sections 43, the outer peripheral ends of the holder arms 32 are located radially outside the outer peripheral ends of the magnets 17. Therefore, a gap 49 is formed between the top portion of each of the magnets 17 and the inner peripheral surface of the magnet cover 21 as shown in FIG. 11. Thus, when the magnet cover 21 is put in position by press-fitting, the inner peripheral surface of the magnet cover 21 does not contact the magnets 17 and hence the magnet cover 21 can be fitted in position without damaging the magnets 17.

In the motor 1, the magnets 17 are anchored to the magnet holder 19 without the magnet cover 21. However, the magnet cover 21 is arranged at the outside of the magnets 17 from the viewpoint of reliability so as to prevent the motor from falling into a locked condition when any of the magnets 17 comes off or is broken. When the magnet cover 21 is put in position by a sort of press-fitting, the magnet holder pieces 42 are pressed further against the corresponding magnets 17, whereby the magnets 17 are held and fixed more rigidly.

Hall elements 8 are arranged radially outside of the sensor magnet 20 at the side of the sensor section 5. A total of three Hall elements 8 for the U-, V- and W-phases are provided. The Hall elements 8 are arranged vis-à-vis the sensor magnet 20 at regular intervals. The magnetic polarities of the sensor magnet 20 correspond to those of the magnets 17, the number of poles of the sensor magnet 20 being same as those of the magnets 17, and are arranged at positions same as those of the magnets 17 as viewed in the peripheral direction. Then, the sensor magnet 20 is rigidly held by the magnet cover 21. In the motor 1, the magnets 17 have six poles structure and the sensor magnet 20 is magnetized to six poles corresponding to the magnets 17. The Hall elements 8 send out signals according to the magnetic polarity changes of the sensor magnets 20, so that the rotary position of the rotor 7 is detected according to those signals.

The Hall elements 8 are arranged in the circumferential direction at the leading end of the sensor holder 22 fitted to the bracket 14. A printed board 24 is fitted to the outside of the sensor holder 22. Both the sensor holder 22 and the printed board 24 are fixed to the bracket 14 by screws 23. An end cap 25 is fitted to the outer end of the bracket 14 to protect the parts of the printed board 24 and other elements contained in the bracket 14 from the external atmosphere. A power supply cable 26 is also connected to the bracket 14 in order to supply a power to the drive coil 11. The power supply cable 26 is lead out of the motor by way of a rubber grommet 27 fitted to the lateral side of the bracket 14.

While the sensor magnet 20 and Hall elements 8 are used to detect the rotary position of the rotor 7 in the above-described first embodiment, they may be replaced by a resolver rotor and a resolver. In this case, the resolver rotor is fitted to the position similar to the sensor magnet 20. The resolver rotor is fixed to the rotor shaft 2. Then, sensor magnet fitting section 33, the small diameter section 21a and the tapered section 21c are taken away from the magnet holder 19 and the magnet cover 21. The resolver is arranged at the position of the Hall elements 8 on the bracket 14.

The present invention is by no means limited to the above-described embodiments, which may be modified and altered in various different ways without departing from the spirit and scope of the present invention.

For example, the present invention is applied to an inner rotor type brushless motor in the above-described embodiment, it can also be applied to a motor with brushes and an electric generator. While rotor magnets 17 can be fixed to a rotor core 16 without using any adhesive according to the present invention, a small amount of adhesive may be used to bond the rotor magnets 17 to the rotor core 16.

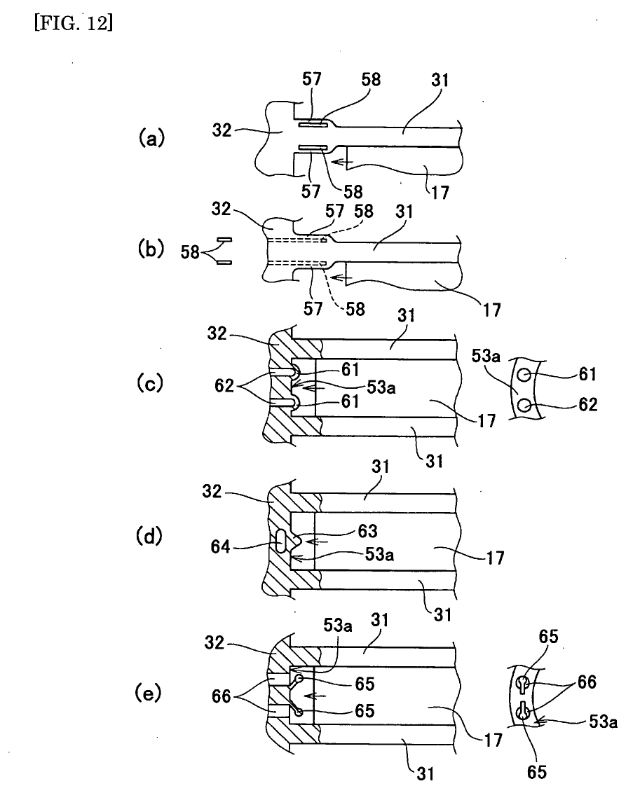

Further, the configuration of the projections 55 formed on the magnet holder 19 as a dimensional adjustment means is not limited to the above embodiment, but may be variously modified. FIGS. 12 (a) to 12 (e) are explanatory views showing modifications of the projections 55. FIGS. 12 (a) and 12 (b) show a configuration in which expanded portions (deformable portions) 57 are formed on the base portion (near the connection portion between the holder arm 32 and holder base 31) of the holder arm 32. In this configuration, when the magnet 17 is inserted, the expanded portions 57 are pressed and crushed. More specifically, in the configuration shown in FIG. 12 (a), a slit 58 penetrates each expanded portion 57 in the radial direction and, when the magnet 17 is brought into contact with the expanded portions 57, the slits 58 collapse to cause the expanded portions 57 to be pressed and crushed. In the configuration shown in FIG. 12 (b), dead-ended slits (cavities) 59 are drilled in the respective expanded portions 57 in the axial direction and, when the magnet 17 is brought into contact with the expanded portions 57, the slits 59 collapse to cause the expanded portions 57 to be pressed and crushed.

FIG. 12 (c) shows a configuration in which dome-shaped projections (deformable portions) 61 are formed on the side wall portion inner end surface 53a. Each projection 61 has a cavity inside and, at the back thereof, a die cavity 62 which is formed at the molding time exists. As in the case of the projections 55 of the abovementioned embodiment, the projections 61 are pressed and crushed when the magnet 17 is brought into contact therewith, so that the accumulated dimensional tolerance of the magnet 17 and the like is absorbed. FIG. 12 (d) shows a configuration in which a projection (deformable portion) 63 is formed on the side wall portion inner end surface 53a and, at the back thereof, a cavity portion 64 is formed. As in the above examples, when the magnet 17 is brought into contact with the projection 63, the cavity portion 64 collapse to cause the projection 63 to be pressed and crushed.

Unlike the above examples, in the configuration of FIG. 12 (e), elastic pieces 65 are formed on the inner end surface 53a not as portions that are to be pressed and crushed but as deformable portions. That is, accumulated dimensional tolerance of the magnet 17 and the like is absorbed by the deformation of the elastic pieces 65. Each of the elastic pieces 65 has a leading end rising in the axial direction. Further, elastic piece housing holes 66 into which the elastic pieces 65 can move are formed in the axial direction at the portions on the inner end surface 53a that face the leading ends of the elastic pieces 65. When the magnet 17 is brought into contact with the elastic pieces 65, the elastic pieces 65 are pushed in the axial direction to be deformed, so that the leading ends thereof arbitrarily move into the elastic piece housing holes 66, whereby the accumulated dimensional tolerance is absorbed.

1. A rotating electrical machine having: a rotor core fixed to a rotary shaft; a plurality of magnets fitted to the rotor core on the outer periphery thereof along the circumferential direction; and a magnet holder including a base portion fixed to the rotary shaft and a plurality of arm members projecting from the base portion in the extending direction of the rotary shaft so as to be able to contain and hold the magnet between the adjacent arm members,
characterized in that
the base portion has a deformable portion which is deformed by being brought into contact with the axial direction end portion of the magnet.

2. The rotating electrical machine according to claim 1, characterized in that
the base portion has an opposite surface that is opposed to the axial direction end portion of the magnet between the adjacent arm members, and
the deformable portion is formed on the opposite surface and is pressed and crushed by being brought into contact with the axial direction end portion of the magnet.

3. The rotating electrical machine according to claim 2, characterized in that
the deformable portion is a projection projecting from the opposite surface.

4. The rotating electrical machine according to claim 3, characterized in that
a cavity is formed inside the projection.

5. The rotating electrical machine according to claim 3, characterized in that
a cavity portion is formed in the base portion at the back of the projection.

6. The rotating electrical machine according to claim 1, characterized in that
the deformable portion is formed near the connection portion between the arm member and base portion and is pressed and crushed by being brought into contact with the axial direction end portion of the magnet.

7. The rotating electrical machine according to claim 6, characterized in that
the deformable portion is an expanded portion expanding in the radial direction.

8. The rotating electrical machine according to claim 7, characterized in that
a slit penetrating the expanded portion in the radial direction is formed in the expanded portion.

9. The rotating electrical machine according to claim 7, characterized in that
a cavity is formed inside the expanded portion.

10. The rotating electrical machine according to claim 1, characterized in that
the base portion has an opposite surface that is opposed to the axial direction end portion of the magnet between the adjacent arm members, and
the deformable portion is an elastic piece formed on the opposite surface and displaced by being brought into contact with the axial direction end portion of the magnet.

11. The rotating electrical machine according to claim 10, characterized in that
an elastic piece housing hole into which the elastic piece can move is formed at the portion on the base portion that faces the elastic piece.
